(19) United States
(12) Patent Application Publication
(10) Pub. No.: US 2025/0128543 A1
(43) Pub. Date: Apr. 24, 2025

(54) STRUCTURE FOR ASSEMBLING SNAP-ON CASTER OF DRAW-BAR CASE

(71) Applicant: Jerry MOON, Taipei City (TW)

(72) Inventors: He HUANG, Dongguan City (CN); Liping YUAN, Dongguan City (CN); Jerry MOON, Taipei City (TW)

(73) Assignee: Jerry MOON, Taipei City (TW)

(21) Appl. No.: 18/632,752

(22) Filed: Apr. 11, 2024

(30) Foreign Application Priority Data
Oct. 21, 2023 (CN) 2023228278597

(51) Int. Cl. B60B 33/00

(52) U.S. Cl. CPC B60B 33/001; B60B 2200/45

(57) ABSTRACT

The present invention provides a structure for assembling a snap-on caster of a draw-bar case. The draw-bar case includes a case body and four caster assemblies. The caster assembly includes a caster and an upper positioning cover. The caster includes a mounting pedestal and a universal wheel. Four sides of the case body are each provided with an installation slot. Several insertion plates are disposed on an inner side surface of the upper positioning cover. The installation slot is penetrated to form a through hole that is disposed corresponding to the insertion plate. The installation pedestal is provided with a buckle plate that is disposed corresponding to the through hole. The buckle plate is penetrated to form an insertion hole. Both sides of one end of the insertion plate are each provided with an inverted buckle. The insertion plate is snap-fitted onto the insertion hole after passing through the through hole and the insertion hole sequentially.

### FIELD OF THE INVENTION

The present invention relates to the technical field of draw-bar cases, and in particular to a structure for assembling a snap-on caster of a draw-bar case.

### BACKGROUND OF THE INVENTION

A draw-bar case is a suitcase having a draw bar and casters and is widely used because of its ease of use. The casters of the existing draw-bar case are generally installed at the four sides of the bottom of the case body through screws. The installation process is cumbersome and the assembling efficiency is low, which restricts the improvement of production efficiency and requires a lot of manpower to assemble the casters, increasing the production cost.

### SUMMARY OF THE INVENTION

The problem to be solved by the present invention is to provide a structure for assembling a snap-on caster of a draw-bar case, which reduces the difficulty of assembling the casters and improves the assembling efficiency.

To solve the aforementioned technical problems, the present invention provides a structure for assembling a snap-on caster of a draw-bar case, including a case body and four caster assemblies. The caster assemblies include a caster and an upper positioning cover. The caster includes an installation pedestal and a universal wheel disposed on the installation pedestal. Four sides of a bottom of the case body are each provided with an installation slot that matches the installation pedestal. An inner side surface of the upper positioning cover is provided with a plurality of insertion plates. A wall surface of the installation slot is penetrated to form a through hole that is disposed corresponding to the insertion plate. The installation pedestal is provided with a buckle plate that is disposed corresponding to the through hole. The buckle plate is penetrated to form an insertion hole that matches the insertion plate. Both sides of one end of the insertion plate are provided with an inverted buckle. The insertion plate is snap-fitted onto the insertion hole after passing through the through hole and the insertion hole sequentially.

Preferably, the installation pedestal includes an arc-shaped base plate, and an edge wrapping portion that is disposed as extending around a circumference of the arc-shaped base plate. The universal wheel is disposed at a bottom of the arc-shaped base plate. The buckle plate is disposed on a top surface of the arc-shaped base plate. A circumference of the installation slot is provided with a position-limiting groove that matches the edge wrapping portion. The edge wrapping portion is disposed on the position-limiting groove.

Preferably, the insertion plate includes a longitudinal connecting plate connected to the upper positioning cover, a longitudinal inserting plate connected to a side surface of the longitudinal connecting plate, and a plurality of transverse position-limiting plates that are disposed in parallel on both side surfaces of the longitudinal inserting plate. The inverted buckle is disposed on one end of the transverse position-limiting plate, and an inclined guiding surface is disposed on a top of one end of the longitudinal inserting plate.

The beneficial effects of the present invention are that: the present invention provides a structure for assembling a snap-type caster of a draw-bar case. When the caster is installed, firstly the upper positioning cover is combined onto the outer wall surface of the installation slot from the interior of the case body, so that each insertion plate of the upper positioning cover is inserted and installed into the corresponding through hole, and the installation pedestal is combined onto the installation slot while the upper positioning cover is pressed, so each insertion plate is snap-fitted onto the insertion hole of the corresponding buckle plate, thereby realizing the quick assembling of the caster, which can effectively reduce the difficulty of assembling the caster, improve the assembling efficiency, reduce manpower input and decrease production cost.

### BRIEF DESCRIPTION OF THE DRAWINGS

FIG. 1 illustrates a schematic diagram of the appearance structure of the present invention;

FIG. 2 illustrates a schematic exploded diagram of the structure of the present invention;

FIG. 3 illustrates a schematic structural diagram of a case body of the present invention;

FIG. 4 illustrates a schematic diagram of an assembled structure of the casters and the upper positioning cover of the present invention;

FIG. 5 illustrates a schematic structural diagram of a caster of the present invention;

FIG. 6 illustrates a schematic structural diagram of the upper positioning cover of the present invention; and

FIG. 7 illustrates a schematic partial enlarged structural diagram of part A in FIG. 4 of the present invention.

### DETAILED DESCRIPTION OF THE PREFERRED EMBODIMENTS

In order to make the objectives, technical solutions and advantages of the embodiments of the present disclosure more clear, the technical solutions of the embodiments of the present disclosure will be described clearly and completely in connection with the accompanying drawings of the embodiments of the present disclosure. Obviously, the described embodiments are some, but not all, of the embodiments of the present disclosure.

Based on the described embodiments of the present disclosure, all other embodiments obtained by those of ordinary skills in the art without creative efforts fall within the claimed scope of the present disclosure.

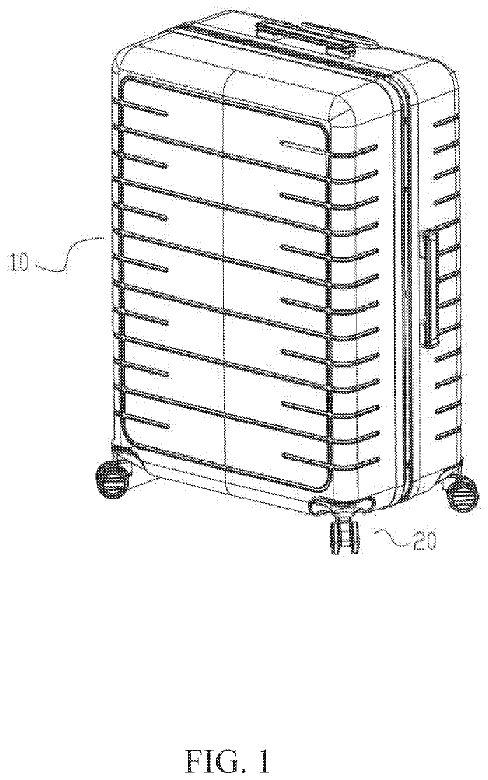

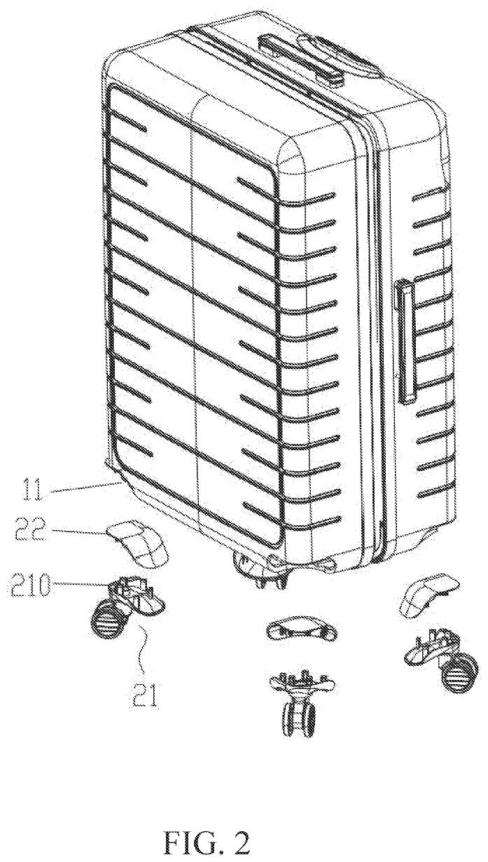

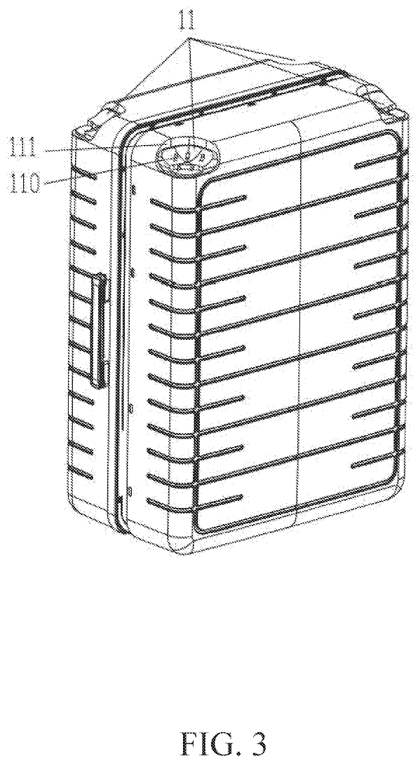

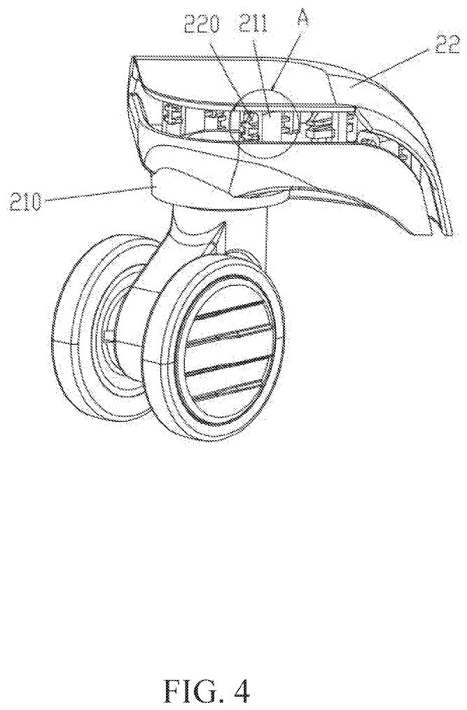

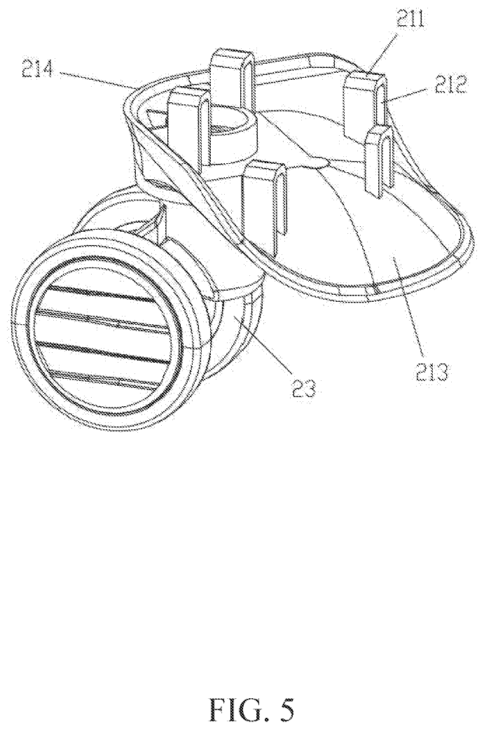

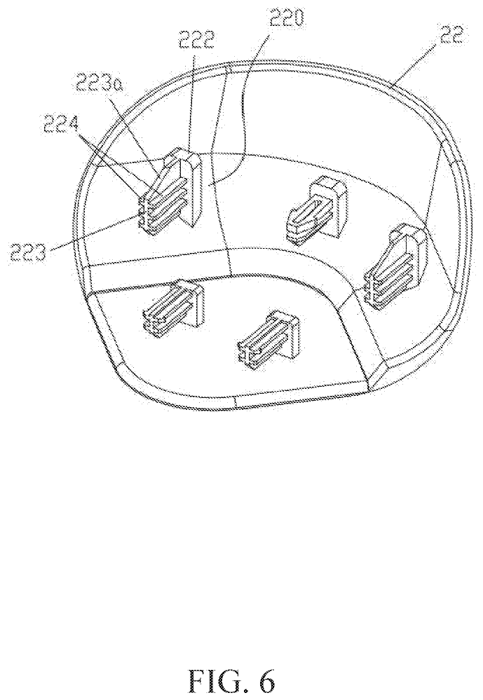

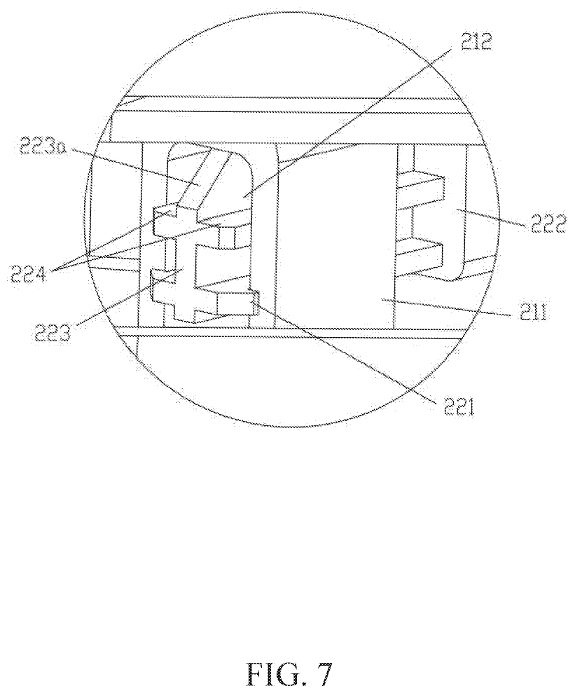

Referring to FIGS. 1-7, the present invention provides a structure for assembling a snap-on caster of a draw-bar case, including a case body 10 and four caster assemblies 20. The caster assembly 20 includes a caster 21 and an upper positioning cover 22. The caster 21 includes an installation pedestal 210 and a universal wheel 23 disposed on the installation pedestal 210. Four sides of a bottom of the case body 10 are each provided with an installation slot 11 that matches the installation pedestal 210. An inner side surface of the upper positioning cover 22 is provided with a plurality of insertion plates 220. A wall surface of the installation slot 11 is penetrated to form a through hole 110 that is disposed corresponding to the insertion plate 220. The installation pedestal 210 is provided with a buckle plate 211 that is disposed corresponding to the through hole 110. The buckle plate 211 is penetrated to form an insertion hole 212 that matches the insertion plate 220. Both sides of one end of the insertion plate 220 are each provided with an inverted buckle 221. The insertion plate 220 is snap-fitted onto the insertion hole 212 after passing through the through hole 110 and the insertion hole 212 sequentially.

Its working principle is that when the caster 21 is installed onto the case body 10, firstly the upper positioning cover 22 is combined onto an outer wall surface of the installation slot 11 from an interior of the case body 10, so that each insertion plate 220 of the upper positioning cover 22 is inserted and installed into the corresponding through hole 110, and the installation pedestal 210 is combined onto the installation slot 11 while the upper positioning cover 22 is pressed, so each insertion plate 220 is snap-fitted onto the insertion hole 212 of the corresponding buckle plate 211, thereby realizing the quick assembling of the caster, which can effectively reduce the difficulty of assembling the caster, improve the assembling efficiency, reduce manpower input and decrease production cost.

Based on the aforementioned embodiments, the installation pedestal 210 includes an arc-shaped base plate 213, and an edge wrapping portion 214 that is disposed as extending around a circumference of the arc-shaped base plate 213. The universal wheel 23 is disposed at a bottom of the arc-shaped base plate 213. The buckle plate 211 is disposed on a top surface of the arc-shaped base plate 213. A circumference of the installation slot 11 is provided with a position-limiting groove 111 that matches the edge wrapping portion 214. The edge wrapping portion 214 is disposed on the position-limiting groove 111. After the installation pedestal 210 is assembled into the installation slot 11, the edge wrapping portion 214 is located on the position-limiting groove 111, which can improve the assembling stability of the installation pedestal 210.

Based on the aforementioned embodiments, the insertion plate 220 includes a longitudinal connecting plate 222 connected to the upper positioning cover 22, a longitudinal inserting plate 223 connected to a side surface of the longitudinal connecting plate 222, and a plurality of transverse position-limiting plates 224 that are disposed in parallel on both side surfaces of the longitudinal inserting plate 223. The inverted buckle 221 is disposed on one end of the transverse position-limiting plate 224, and an inclined guiding surface 223a is disposed on a top of one end of the longitudinal inserting plate 223. Specifically, a distance between an outer end surfaces of two transverse position-limiting plates 224 matches a width of the insertion hole 212. When the installation pedestal 210 is assembled onto the installation slot 11, the insertion hole 212 on each buckle plate 211 is aligned with a corresponding insertion plate 220 and pushes the installation pedestal 210 horizontally toward a side of the installation slot 11. The transverse position-limiting plate 224 will move along a wall surface of the insertion hole 212, until the inverted buckle 221 completely runs through the insertion hole 212 and then the inverted buckle 221 is snap-fitted onto the insertion hole 212. The inclined guiding surface 223a plays a guiding role in a process when the insertion plate 220 is inserted into the insertion hole 212, which can ensure stable snap-fitting between the insertion plate 220 and the insertion hole 212.

The aforementioned embodiments are only descriptions of preferred embodiments of the present invention, and do not limit the scope of the present invention. Various variations and modifications made onto the technical solutions of the present invention by those of ordinary skills in the art without departing from the design spirit of the present invention, should all fall within the claimed scope determined by the claims of the present invention.

What is claimed is:

1. A structure for assembling a snap-on caster of a draw-bar case, comprising a case body and four caster assemblies, the caster assemblies comprises a caster and an upper positioning cover, the caster comprises an installation pedestal and a universal wheel disposed on the installation pedestal, four sides of a bottom of the case body are each provided with an installation slot that matches the installation pedestal, an inner side surface of the upper positioning cover is provided with a plurality of insertion plates, and a wall surface of the installation slot is penetrated to form a through hole that is disposed corresponding to the insertion plate, the installation pedestal is provided with a buckle plate that is disposed corresponding to the through hole, the buckle plate is penetrated to form an insertion hole that matches the insertion plate, both sides of one end of the insertion plate are provided with an inverted buckle, and the insertion plate is snap-fitted onto the insertion hole after passing through the through hole and the insertion hole sequentially.

2. The structure for assembling a snap-on caster of a draw-bar case according to claim 1, wherein the installation pedestal comprises an arc-shaped base plate and an edge wrapping portion that is disposed as extending around a circumference of the arc-shaped base plate, the universal wheel is disposed at a bottom of the arc-shaped base plate, the buckle plate is disposed on a top surface of the arc-shaped base plate, a circumference of the installation slot is provided with a position-limiting groove that matches the edge wrapping portion, and the edge wrapping portion is disposed on the position-limiting groove.

3. The structure for assembling a snap-on caster of a draw-bar case according to claim 2, wherein the insertion plate comprises a longitudinal connecting plate connected to the upper positioning cover, a longitudinal inserting plate connected to a side surface of the longitudinal connecting plate, and a plurality of transverse position-limiting plates that are disposed in parallel on both side surfaces of the longitudinal inserting plate, the inverted buckle is disposed on one end of the transverse position-limiting plate, and an inclined guiding surface is disposed on a top of one end of the longitudinal inserting plate.
